(19) United States
(12) Patent Application Publication
(10) Pub. No.: US 2023/0182493 A1
(43) Pub. Date: Jun. 15, 2023

(54) PRINTING DEVICE AND METHOD FOR PRINTING ON A WORKPIECE

(71) Applicant: HOMAG GmbH, Schopfloch (DE)

(72) Inventors: Johannes SCHMID, Starzach-Wachendorf (DE); Patrick MÜLLER, Glatten (DE); Alija HODZA, Freudenstadt (DE)

(21) Appl. No.: 18/080,435

(22) Filed: Dec. 13, 2022

(30) Foreign Application Priority Data
Dec. 14, 2021 (DE) 102021133047.5

(51) Int. Cl. B41J 25/304

(52) U.S. Cl. CPC B41J 25/304

(57) ABSTRACT

A printing device is provided for printing on a workpiece, which preferably comprises at least partially wood, wood fiber containing materials, wood composite materials, veneer, plastic, or a combination thereof. The printing device can include a housing, a holding element arranged on the housing, a print head attached to a first side of the housing, and a first interface. The first interface can communicatively and operatively connect the print head to containers for print media. Further, the printing device can be portable.

### BACKGROUND

### Field of the Inventions

The invention relates to a printing device suitable for printing on a workpiece, which preferably comprises at least in sections wood, wood fiber containing materials, wood composite materials, veneer, plastic or a combination thereof. Furthermore, the invention relates to a method for printing on the workpiece.

### Description of the Related Art

In the field of mobile printing devices for printing on workpieces, those are known that generate an imprint consisting of numbers, date, time, text, 1D continuous, 2D code, graphic by a pulling movement of the printing device over the workpiece. The known mobile printing devices are mostly marking devices.

Since the known mobile printing devices are only suitable for marking, they cannot print a multi-color or multi-component decor.

Furthermore, known mobile printing devices have a print head height of 1 mm to 12.7 mm or 24.5 mm. Thus, the known print head heights are smaller than 25 mm.

In the field of stationary printing devices, those are known which use a digital printing process to print a decor (e.g., a decoration or a pattern) on a layer which is then applied to a workpiece as a decorative layer. The decorative layer is characterized, for example, by a relief (surface embossing) and a specific color spectrum. A decorative layer can have a synchronous pore, for example. For example, the decorative layer can have a 3D look and feel that mimics naturally occurring wood.

However, there is a problem in that, for example, due to a damage to the workpiece, the decorative layer can no longer be repaired by the stationary printing devices after production. This means that damaged workpiece sections cannot be repaired by the stationary printing device.

So far, damaged workpieces that show a defect are returned to the manufacturer or discarded or recycled. Thus, no sustainable use of resources takes place.

### SUMMARY

The invention is based on the problem of providing a printing device with which a damaged workpiece can be repaired easily, quickly, and cost-effectively. This means that it is no longer necessary to discard the workpiece or a complex return transport to the manufacturer is avoided.

A printing device is defined in claim 1. A method for printing on a workpiece is defined in claim 6. Dependent claims relate to specific embodiments.

The printing device for printing on a workpiece, which preferably comprises at least partially wood, wood fiber containing materials, wood composite materials, veneer, plastic, or a combination thereof, wherein the printing device comprises: a housing, a holding element disposed on the housing, a print head mounted on a first side of the housing, and a first interface (particularly disposed in the housing), wherein the first interface communicatively and operatively connects the print head to containers for print media, and the printing device is portable.

The printing device is suitable for printing on a workpiece. In particular, the workpiece may be a piece of furniture for a living room, bathroom or kitchen, or a door component of the door industry. For example, the workpiece may have an upper surface and a lower surface, and a narrow side. In particular, the workpiece may have 6 sides, wherein at least one side is a narrow side. For example, the narrow side may be a side surface of the workpiece. In particular, the workpiece may have an edge band on the narrow side. Preferably, the workpiece may have a decorative layer on at least one surface. Preferably, the decorative layer may have a synchronous pore on the surface of the workpiece.

The printing device may have a controller arranged in the housing, the controller being configured to control the print head, and a first interface arranged in the housing. According to a further embodiment, the controller may also be disposed externally, and the printing device may be connected to the controller by a data connection. For example, the controller is carried by an employee on the body and the printing device is connected to the manually operated printing device by a cable.

The printing device may be configured to print on each side of a workpiece that may have different surfaces. Preferably, the printing device performs a digital printing process. In particular, the digital printing process is an inkjet process. For example, the printing device may be a small mobile inkjet printer or a small mobile inkjet printer. For example, the printing device may be a matrix printer. This makes it possible to repair a damaged workpiece easily, efficiently and flexibly, thereby avoiding unnecessary return transport to the manufacturer and using resources sustainably. Repairing the workpiece can prevent the damaged workpiece from being discarded. Printing on different surfaces, such as PVC, PP, ABS, melamine, veneer, and/or solid wood is possible with the printing device.

The printing device is portable. The term portable means that the printing device can be easily and uncomplicated carried, and thus can be transported from one location to another. The printing device may also be movable, mobile, or portable. For example, the printing device is not tied to a fixed location. For example, the printing device is not heavier than 10 kg, in particular not heavier than 5 kg and/or not lighter than 100 g. The printing device can thus be used flexibly at different locations, thus avoiding the need to transport the workpiece back. The printing device can be easily used by a user, so that a repair of a damaged workpiece can be carried out quickly and easily on site.

The printing device has a housing. The housing can have different shapes. Preferably, the housing has a rectangular shape. The housing has a first side, and preferably a second side, a third side, and a fourth side. In particular, the first side through the fourth side are side surfaces of the housing. The first side and the third side may be opposite to each other. The second side and the fourth side may be opposite to each other. Preferably, all components of the printing device are provided in the housing so that they are protected from possible damage.

Further, the housing may have an upper surface and a lower surface, the lower surface being parallel to the upper surface. Thus, the upper and lower surfaces are opposite each other.

A holding element is arranged on the housing. An example of a holding element is a handle, which is arranged or attached in particular to the lower surface of the housing. Furthermore, the handle may be ergonomically designed. For example, the handle may have a textured surface in an area where a user's hand grips the handle. Other known options and structures of a handle may also be possible. For example, the holding element may be a strap. Alternatively, the holding element may be a band that is connected to the housing via two fastening elements that may be attached to the housing. For example, the holding element may be a band (rubber band or hook and loop tape (Velcro)) that is attached to the housing via eyelets. The band may be releasably attachable to a wrist of the user. The printing device is designed for left-handed, right-handed or even two-handed users. The holding element allows the printing device to be easily and safely carried. For example, the user of the printing device can carry the printing device by the holding element.

Furthermore, the printing device has a print head. The print head is attached to the first side of the housing. The print head is communicatively and operatively connected to more than one print media container by means of a first interface. For example, the print head may be communicatively and operatively connected to two, three, four, or more than four print media containers by means of the first interface. The print head is preferably connected to a controller. The print head may be configured to dispense multiple print media, particularly simultaneously, to the workpiece. The print head may preferably be configured to dispense multiple print media, in particular two or more than two print media, to the workpiece simultaneously. The print head can thus be controlled by the controller to print a decor on the workpiece in a controlled manner. In particular, the print head can dispense at least two or more print media to the workpiece simultaneously. In particular, the print head may dispense four or more print media, preferably simultaneously, on the workpiece. More specifically, the print media may be ink. For example, the print head can dispense the print media cyan, magenta, yellow and black to the workpiece and optionally light cyan and light magenta. Thus, it can be achieved that the destroyed decorative layer of the workpiece can be repaired in high quality.

For example, the decor may comprise at least two print media. In particular, the decor may be formed from cyan, magenta, yellow, and/or black print media. The print head may further be configured to print the print media from the at least two containers on the surface of the workpiece. The decor may be a printed image. The decor may be a RAL color. The decor may have a pattern. Thus, the workpiece can be repaired to a high quality quickly and easily.

The printing device may have a fast-drying and high-resolution printing medium with high adhesive force. The print head may be configured to create a decor on the surface of the workpiece. Further, the print head may be controlled by the controller to print a positionally accurate and sharp image/design on the workpiece. Thus, it can be achieved that the damage to the workpiece after printing by the printing device is not until hardly visible. The print head can, for example, be configured to shoot or deflect small ink droplets through the air from the print head onto the workpiece in a controlled way. Thereby, the print medium, in particular the ink or paint, can be transported from the containers to the print head via the first interface. Furthermore, the print head may have multiple and at least two nozzles for dispensing a print medium. This can improve and accelerate the printing process and increase the print quality.

In the course of a printing process, preferably liquid print media are applied to a workpiece. In particular, it is an inkjet printing process, a spray application or a layer-by-layer application (for example 3D printing).

A print medium is, for example, a printing ink, ink, a primer or a varnish.

The print head may preferably have a rectangular shape. In particular, the print head may be arranged on an outer surface of the housing. The print head may be arranged to extend along the first side of the housing in a first direction and to extend in a second direction that is perpendicular to the first direction. The first direction may be a horizontal direction and the second direction may be a vertical direction. Preferably, the printing device is moved in the first direction during the printing process.

Preferably, the print head has a size in the second direction in the range from 2 mm to 70 mm, in particular from 8 mm to 63 mm. In particular, the print head has a size of 15 mm in the vertical direction. In particular, the print head consists of one piece. For example, the print head has a size in the second direction corresponding to a height of the narrow side of the workpiece. Due to the size of the print head, it is possible to repair the workpiece in one printing process, i.e., with one movement of the printing device over the damaged surface of the workpiece. Thus, the repair process can be accelerated.

According to one embodiment, the controller is arranged in the housing. The controller is configured to control the print head. The controller may be further configured to control the first interface. For example, the controller may be configured to control the first interface such that the at least one print media is transported from the at least one print media container to the print head by means of the first interface. Furthermore, the controller may include a processor and a memory. In this regard, the controller may be a known controller capable of performing the method according to the invention. The controller simplifies the printing process, and the repair can be performed more quickly and effectively.

The first interface is disposed within the housing. A portion of the first interface may be disposed on an outer surface of the housing. In particular, the first interface may be disposed on an outer surface of the third side or upper surface of the housing.

The first interface communicatively and operatively connects the print head to the more than one container. For example, the first interface is configured to receive the more than one container. For example, the first interface passes more than one print media of the more than one container from the more than one container to the print head. The first interface may convey multiple different print media from the multiple containers to the print head. The first interface can communicatively and operatively connect two, three, four, or more than four containers to the print head. For example, the first interface can include conduits and adapters that can be connected to the at least one container. For example, the first interface may comprise the more than one container. Thus, through the first interface, print media can be provided to the printing device, whereby the repair of the workpiece is carried out. Through the first interface, it is possible for the print head to print a decor quickly and easily on the surface of the workpiece.

For example, a container may be a known ink cartridge. Preferably, the container comprises a printing ink, an ink, a primer, or a varnish. Preferably, one container of the at least two containers may include a solution for impregnating and/or sealing the printed surface of the workpiece. For example, one container may comprise cyan, magenta, yellow and/or black and optionally light cyan and/or light magenta. By having more than one container, it is achieved that the decor is applied to the surface of the workpiece, so that the damaged area of the workpiece cannot be noticed at all or hardly at all. Thus, the damaged decorative layer can be printed with a suitable decor so that the workpiece is again free of damage.

The advantages of the printing device according to the invention are a higher flexibility and mobility in the production of the workpieces and at the intermediate dealer or customer. The printing device enables damage to be repaired more quickly, e.g., directly in production, at the dealer or intermediary dealer, and at the end customer. This means that complaints and damage can be rectified directly on site. This also means that return transport or disposal of the damaged workpiece is no longer necessary.

Another advantage of the printing device according to the invention is that it is quick and easy to operate, so that changing customer requirements can be met easily and quickly. Furthermore, the printing device according to the invention allows a damaged workpiece to be completely repaired again easily and inexpensively.

The printing device according to the invention can, for example, print a new edge band of a damaged and previously unprinted workpiece. The printing device according to the invention allows damages to be repaired already during production. Damage at the intermediary dealer (e.g., distributor) or end customer can also be repaired easily, quickly, and inexpensively by the printing device. Manual, individual design adjustments can also be made at the end customer's site by means of the printing device.

Furthermore, the printing device enables a cost-effective production option to produce very small batch sizes. For example, very small batch sizes can be produced inexpensively, easily, and quickly at the manufacturing company or directly at the customer's site.

The printing device according to the invention solves the disadvantage that in the case of many workpieces already being delivered, the narrow side (e.g., the edge band) has to be subsequently reapplied or peeled off again and reapplied at the customer's site or other external field applications. In this case, the available edge band is very rarely available in the individual customer-specific color and especially not in the customer-specific decor.

Furthermore, the printing device according to the invention solves the disadvantage that damages of the workpiece sides (upper and lower side or narrow sides) during for example assembly, transport or other reasons in production can be repaired quickly and flexibly with such a printing device in the current production step in which the defect was detected, without transporting the workpiece back to the production line and thus hindering the manufacturing process or, in the worst case, the entire workpiece has to be disposed of.

Furthermore, damage to the narrow side of the workpiece at the customer or intermediary dealer in the field (i.e. outside the production plant of the workpieces), e.g. due to transport, assembly or other reasons, can be repaired quickly and flexibly with a printing device according to the invention, without the workpiece having to be returned to the manufacturer, a new workpiece having to be supplied by the manufacturer as a gesture of goodwill or, in the worst case, the entire damaged workpiece having to be disposed of.

Possible damage to the workpiece can be eliminated by the method according to the invention, for example. Depending on the degree of damage, the affected area of the workpiece (e.g., damage, scratched area, or defective area) must first be repaired with a filler. The manual digital printing of the present invention can only be applied to a relatively flat structure, so that a prior surface pretreatment is necessary. Deep holes in the upper and/or lower surface as well as edges must first be repaired with a filler and an adhesive primer. In the case of a large damage to the edges, the damaged edge band would first have to be removed and a new edge band would have to be reapplied.

In a further embodiment, the printing device may comprise a device holder which can be coupled to the housing and/or comprise a guide element along which the printing device may be moved on a surface of the workpiece.

The device holder may further have joints, so that the printing device is attached to the device holder and can be moved in all three spatial directions. The device holder can be attached to a machine table or other ground, for example. In this way, it can be achieved that the printing device can uniformly print the workpiece. For example, when using a device holder, the workpiece and not the printing device can be moved. In particular, the device holder may be mounted in a CNC machine. By using the device holder, the housing, and thus the entire portable printing device, can be attached, so that any movements that can affect the print quality can be reduced. Through the device holder, the printing device can be fixed stationary and temporary.

For example, the device holder is a robot arm. The device holder can also be designed as a multi-axis head, for example a 5-axis head.

The printing device may have a guide element or may be positioned manually on a surface of the workpiece. The printing device may preferably be positioned at a distance of 3 mm from the surface of the workpiece. For example, the guide element may be at least one attached guide roller on the print head. Alternatively, the guide element may be a separate auxiliary device with rails to provide guidance for the printing device. The guide element can guide the printing device along the surface of the workpiece in one direction. For example, the guide element may be a rail in which the printing device is guided along. Alternatively, the guide element may be at least one known guide roller on which the printing device can be moved constantly in one direction. The purpose of the guide element is to ensure that the printing device is moved uniformly in one direction, so that a very good printing quality is achieved. Thus, undesired movements in another direction can be prevented by the guide element.

In a further embodiment, the printing device may have a print head configured to deliver multiple print media to the workpiece (particularly simultaneously). Thus, the damaged decor or pattern of the surface of the workpiece is printed in a cost-effective and efficient manner and thus repaired.

The printing device is a mobile printing device that may or may not be equipped with a sensor.

In another embodiment, the printing device may comprise a first sensor on the first side of the housing adjacent to the print head. The first sensor may be configured to detect and analyze a surface of the workpiece in at least a section thereof, wherein the first sensor is connected to the controller and provides data about the detected and analyzed surface to the controller. Thus, the first sensor detects and analyzes the decor or structure of the surface of the workpiece. Thus, the first sensor determines which pattern needs to be repaired. Thus, the repair that is performed by the printing device becomes more cost effective and improved.

Preferably, the first sensor may be connected to the controller and provide data to the controller about the detected and analyzed surface. Preferably, the first sensor can be arranged adjacent to the print head on the first side of the housing. Thus, a scan function of the workpiece decor can be performed using the first sensor. For example, the first sensor may optically detect the surface of the workpiece. Preferably, the first sensor is a laser.

In a further embodiment, the controller of the printing device may be configured to evaluate the data of the first sensor and output a job to print the color spectrum to the print head based on the data of the first sensor. The controller may receive and evaluate the data of the first sensor. For example, the controller may compare the received data about the surface structure of the workpiece to a surface structure of a database. Further, if the determined surface structure and the surface structure of the database match, the controller may select the data from the database and output the print job to the print head based on this data. Thus, it is possible for the controller to quickly identify the pattern to be repaired and print the identical pattern on the workpiece efficiently and cost-effectively using the printing device.

During the printing process, the print head can be moved manually past the surface of the workpiece to be printed at a relatively constant speed. Since the fast manual hand movement is never performed evenly, an additional second sensor may ensure that the print media supply is controlled during the printing process. The printing device may have a second sensor that detects the movement of the printing device relative to the workpiece. The speed data can be passed from the second sensor to the controller, so that the controller can adjust the print speed of the print head based on the speed data. Thus, a precise and sharp printing result is ensured.

In another embodiment, the printing device may comprise a second interface. The second interface may be configured to transmit data from the controller to an external device, and to receive data from the external device and transmit it to the controller. The external device may be, for example, a PC or a laptop. Preferably, the second interface may be connected to a data cable. For example, the second interface may comprise a USB port or a USB-C port. In particular, the second interface can wirelessly transmit and receive data to the external device, such as via Bluetooth or WLAN (so-called wireless local area network). The data may have different formats and resolutions. In particular, the data may have data about the desired target decor.

In a further embodiment, the printing device may comprise a third interface. The third interface may preferably be connected to a battery or an external power connection. For example, the third interface may be disposed on an outer surface of the housing. The third interface may, for example, receive a battery to supply power to the printing device. The power connection may be, for example, a 220V/380V connection. The third interface allows the printing device to be mobile and flexible in use on site.

Further, in another embodiment, the printing device may include a graphical user interface which is arranged on the housing and operatively connected to the controller. For example, the graphical user interface is a display or a touch display or a touch screen. Multiple language selections are possible.

The print resolution of the printing device may preferably be 600 dpi×600 dpi. Thus, improved print quality can be achieved.

The invention further relates to a method. In particular, the method may be carried out with the printing device according to the invention.

The method for printing on a workpiece may print a workpiece which preferably comprises at least partially wood, wood fiber containing materials, wood composite materials, veneer, plastic, or a combination thereof. A printing device may perform the following method. The method comprises the steps of: selecting a decor; positioning a portable printing device, in particular a print head, on a section of the workpiece; providing print media from containers via a first interface to the print head; printing the section of the workpiece by the print head of the printing device with the print media.

The method is designed for printing on the workpiece, so that the damaged workpiece can be repaired efficiently and cost effectively. The printing device may preferably include a housing, a print head, a controller, and a first interface disposed in the housing. The first interface communicatively and operatively connects the print head to more than one container.

In one embodiment, the method of printing a workpiece may comprise the step of: applying a material to the section of the workpiece before positioning the printing device, and/or removing a material from the section of the workpiece before positioning the printing device, and before the step of applying a material to the section of the workpiece. Thus, the surface of the damaged workpiece can be pretreated by, for example, applying a new edge band, so that the print quality is improved.

In one embodiment, the method for printing on a workpiece may further transfer data from an external device to the printing device via a second interface in the selecting step. Thus, data about the color spectrum for the printing process can be stored and retrieved on an external device. Thus, the repair process can be accelerated and improved. Also, a high print quality can be achieved since the exact color spectrum for the printing process can be selected.

In the method for printing on a workpiece, in one embodiment, the positioning of the printing device on a section of the workpiece may be performed by a device holder coupled to a housing of the printing device and/or the positioning of the printing device on a section of the workpiece may be performed via a guide element, wherein the printing device may be moved along a surface of the workpiece by the guide element. Thus, unwanted movements, such as wobbling or deviation from the printing direction, can be prevented. This can improve the print quality.

In the method for printing on a workpiece, in one embodiment, in the step of printing the section of the workpiece, the print media can be provided to the print head simultaneously. Thus, the printing method can be accelerated and simplified, so that the repair can be performed more efficiently.

In a preferred embodiment, the method for printing on a workpiece may further comprise the steps of: detecting and analyzing a surface of the workpiece at least in a section by a first sensor, wherein the first sensor is connected to a controller; providing data about the detected and analyzed surface from the first sensor to the controller; and wherein in the step of selecting the decor the data from the first sensor is used. By detecting and analyzing the surface of the workpiece by a sensor, it is achieved that the decor or pattern or surface structure is detected quickly and easily. Thus, the repair of the workpiece can be done faster.

Furthermore, in a preferred embodiment, the step of selecting the decor can be performed by the controller, wherein the controller evaluates the data of the first sensor and outputs an order to print the color spectrum to the print head based on the data from the first sensor. The controller can thus determine the decor of the workpiece to be repaired. The controller can output a print job based on the selected decor. This speeds up the repair process and the workpiece is printed or repaired in a high quality.

In one embodiment, the method for printing on a workpiece may include a computer-implemented method for determining a surface structure of a workpiece. The computer-implemented method comprises the steps of: detecting and analyzing a surface structure of the workpiece at least in a section by the first sensor; sending data containing information about the detected and analyzed surface structure from the first sensor to the controller; receiving data by the controller about the detected and analyzed surface structure from the first sensor; determining the existing decor of the surface structure based on the received data by the controller; selecting the decor; transmitting a print job to print the decor from the controller to the print head of the printing device.

The controller of the printing device may be configured to detect the damaged area due to a pattern error. The controller may determine which pattern should be printed on that section of the workpiece due to the detected pattern error, which is the damaged section of the surface of the workpiece. In other words, the controller analyzes the pattern of the damaged section of the workpiece detected by the first sensor and determines which pattern/print medium, in particular color, surface texture needs to be printed by the print head. Thus, the workpiece can be printed in an improved quality, so that the damage is not visible at all or barely visible.

The computer-implemented method for determining a surface structure of a workpiece may comprise, in the step of the determining the existing decor of the surface texture, sending data to the external device and receiving encoded data from the external device, wherein the received data comprising information of the determined surface structure. By retrieving data, the method can be accelerated because, for example, an external database can be accessed. Thus, the repair can be accelerated and of improved quality.

For example, the controller may send data about the detected decor of the damaged surface of the workpiece to an external device to subsequently receive data for a print job of the decor. This data for a print job may be stored in a database. Preferably, image dot addressing may be performed dynamically for each individual print job. For example, a pattern of the surface may be detected in the method and the pattern may be completed again in the method. This offers the advantage that the damage is no longer visible or recognizable after the repair, if at all.

### BRIEF DESCRIPTION OF THE DRAWINGS

Further features and advantages of a device and method will be apparent from the following description of embodiments with reference to the accompanying drawings. Of these drawings shows:

FIG. 1 a perspective view of a first embodiment of a printing device according to the disclosure;

FIG. 2 a perspective view of a second embodiment of a printing device according to the disclosure;

FIG. 3 two perspective views A, B of a third embodiment of a printing device according to the disclosure;

FIG. 4 a perspective view of a fourth embodiment of a printing device according to the disclosure;

FIG. 5 a perspective view of a fifth embodiment of a printing device according to the disclosure.

### DETAILED DESCRIPTION

Identical reference signs listed in different figures designate identical, corresponding, or functionally similar elements.

The mobile or portable printing device can be used, for example, in the following different embodiments (i) as a mobile manual printing device; (ii) as a mobile manual printing device with a pivotable device holder; (iii) as a mobile manual printing device as a tabletop device with fastening element and device holder (e.g. device holder and stand); (iv) as a mobile manual printing device with attachment for the wrist; or (v) as a mobile machine printing device with adaptation for mobile small CNC tabletop machines or medium to large CNC machines. Here, the difference between the embodiments is that the printing device is equipped with further elements in each case. The same printing device 1 may be installed in the respective embodiments.

Therefore, the printing device 1 of the first embodiment is described first, followed by the further embodiments.

### First Embodiment

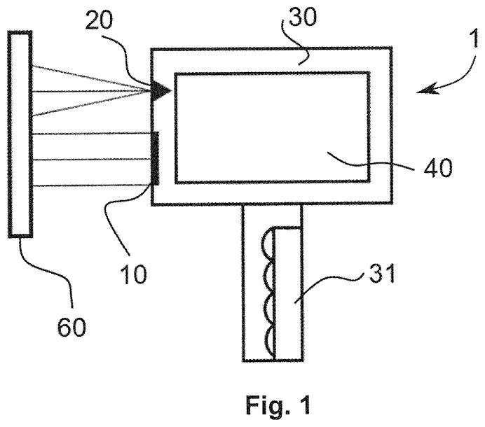

FIG. 1 illustrates a printing device 1 of a first embodiment, the setups of which are described in more detail with reference to FIG. 1.

The printing device 1 is configured for printing on a workpiece 60. The workpiece 60 may comprise, at least in sections, wood, wood fiber containing materials, wood composite materials, veneer, plastic, or a combination thereof. Preferably, the workpiece 60 may be a workpiece plate having an upper surface, a lower surface, and four side surfaces (FIG. 1). In this case, the upper surface of the workpiece 60 faces the printing device 1. However, it is also possible that the printing device 1 faces a side surface or a narrow side of the workpiece 60. The printing device 1 comprises a housing 30, a holding element 31 arranged on the housing 30, a print head 10 mounted on a first side of the housing 30, and a controller disposed in the housing 30 (FIG. 1). The controller is configured to control the print head 10. The print head 10 may be configured to deliver more than one print medium (in the present embodiment, a color), particularly a color spectrum, to the workpiece 60 simultaneously. The print head 10 may be spaced from a surface of the workpiece 60 by a distance that may be 1 mm to 1 cm, preferably 1 mm to 3 mm. [Control external]

Further, the printing device 1 comprises a first interface arranged in the housing 30, wherein the first interface communicatively and operatively connects the print head 10 to more than one print media container (e.g., color container), and the printing device 1 is portable. The more than two print media containers may be received in the housing 30 of the printing device 1, so that they are portable with the printing device 1. Moreover, the first interface is configured to transport a print medium from the more than two containers to the print head 10. The controller is configured to control the first interface as well as the print head 10, so that more than two print media from the more than two print media containers are supplied to the print head 10, and the print head 10 prints the print media on the surface of the workpiece 60. During the printing process, the print head 10 may be manually moved past the surface of the workpiece 60 to be printed at a relatively constant speed. Since the fast manual hand movement is never performed smoothly, an additional second sensor may ensure that the print media supply is controlled during the printing process. The second sensor may also be integrated in the first sensor 20. This ensures precise and sharp printing results.

The housing 30 may further comprise a user interface 40 (FIG. 1). This user interface 40 may be a touch display. The user interface 40 may be configured to display data about the surface of the workpiece 60 to a user of the printing device 1, and to allow the user to manually select a color spectrum to be printed by the print head 10.

The holding element 31 may be a handle that is ergonomically shaped (FIG. 1). The holding element 31 allows the user to easily carry the printing device 1.

Additionally, the printing device 1 may comprise a device holder 50 (not shown in FIG. 1) which can be coupled to the housing 30. The printing device 1 may further comprise a guide element 33 (not shown in FIG. 1) along which the printing device 1 may be moved on the surface of the workpiece 60. For example, the guide element 33 may comprise at least one guide roller.

The printing device 1 further comprises a first sensor 20 on the first side of the housing 30 adjacent to the print head 10 (FIG. 1). The first sensor 20 is configured to detect and analyze a surface of the workpiece 60 at least in a section, wherein the first sensor 20 is connected to the controller and provides data about the detected and analyzed surface to the controller.

In addition, the controller is configured to analyze the data from the first sensor 20 and output an order to print the color spectrum to the print head 10 based on the data from the first sensor 20. In other words, the controller receives the analyzed surface data from the first sensor 20 and determines which surface the workpiece 60 has based on the received data. For example, the controller determines that a particular pattern and/or structure is present on the analyzed surface. This determined surface of the workpiece 60 may, for example, be stored in a database that can be accessed by the controller. The database contains data on various surface structures, surface colors, and surface patterns. Based on the determined surface, the controller may associate a known pattern from the database with these determined data. For example, the known pattern is stored in the database with exact color data. Thus, the controller can determine the exact color spectrum based on the determined surface. Further, the controller can pass the determined color spectrum to the print head 10 as a print job. Thus, the print head 10 receives a print job to print the determined color spectrum on the surface of the workpiece 60.

In the first embodiment, a relative movement is performed with the printing device 1 and the workpiece 60 remains stationary. Thus, the workpiece 60 is not moved in the first embodiment.

### Second Embodiment

In a second embodiment of the printing device 1, the printing device of the first embodiment may be used. The second embodiment differs from the first embodiment in that further elements are provided on the printing device 1.

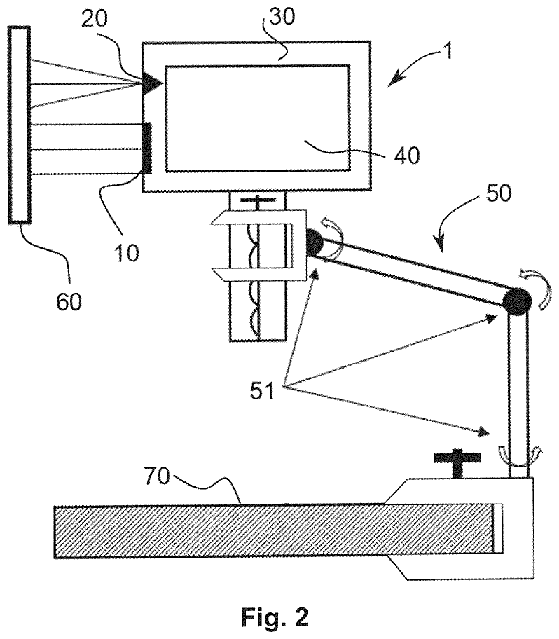

FIG. 2 illustrates a printing device 1 of a second embodiment, the setups of which are described in more detail with reference to FIG. 2.

In the second embodiment, the printing device is provided with a pivotable device holder 50 (FIG. 2). A device holder 50 can be coupled to the holding element 31 of the printing device 1. In other words, the device holder 50 is attachable to the printing device 1 and detachable again (without damage). This device holder 50 facilitates the operation and handling of the printing device 1.

The printing device 1 of the second embodiment comprises a device holder 50 that can be fixed to a support 70 in a stationary and detachable manner (FIG. 2). The support 70 is a machine table. The device holder 50 can be fastened to the printing device 1 via screw clamps (FIG. 2). The device holder 50 can be attached to the support 70 via screw clamps. Alternatively, other known fastening elements may be used instead of screw clamps. The device holder 50 further has at least three joints 51 (FIG. 2), which allow a relative movement of the printing device 1 in all spatial directions. Thus, the printing device 1 can be releasably attached to the device holder 50 and the device holder 50 can in turn be releasably attached to a support 70.

For printing on the surface of the workpiece 60, in this situation, the workpiece 60 must perform a relative movement to the printing device 1, i.e., the workpiece 60 is moved past the print head 10 at a certain constant speed. Thus, the second embodiment differs from the first embodiment in that the print head 10 is now no longer moved over the workpiece 60. The advantage of the second embodiment is that it allows small workpieces 60, which can be handled manually in terms of size and weight, to be printed by the printing device 1. For larger workpieces 60, it is easier to perform the relative movement using the printing device 1 as shown in the first embodiment.

### Third Embodiment

In a third embodiment, the printing device of the first or second embodiment may be used. The third embodiment differs from the first embodiment in that the printing device 1 is now fixed in a stationary manner via a device holder 50. The third embodiment differs from the first embodiment in that the printing device 1 can be fixed or held by a further device holder 50.

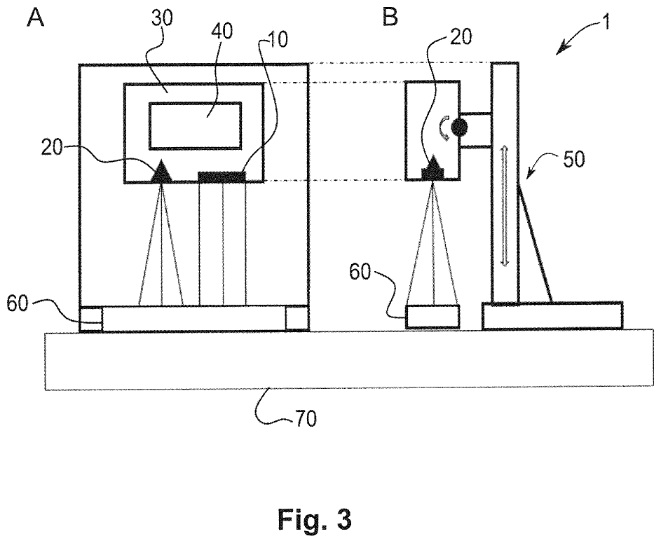

FIG. 3 illustrates a printing device 1 of a third embodiment in a view A and a view B, the setups of which are described in more detail with reference to FIG. 3. FIG. 3 illustrates the printing device of the third embodiment from two different views, one from the front (view A) and one from the side (view B).

The device holder 50 of the third embodiment has at least one arm with joints and a stand (FIG. 3—view B). The device holder 50 of the third embodiment allows the printing device 1 to be independently fixed in a stationary manner on a support 70. The stand is thereby height adjustable, which is indicated in FIG. 3 (view B) by the arrow with two directions. In addition, the arm can be aligned horizontally by one joint, which is illustrated in FIG. 3 (view B) by the arrow with one direction. The printing device 1 of the third embodiment is thereby held by the device holder 50 (FIG. 3—view A and B).

The device holder 50 facilitates operation and increases printing quality and printing accuracy. For printing on the surface of the workpiece 60, in this embodiment, the workpiece 60 must perform a relative movement to the printing device 1, i.e., the user manually passes the workpiece 60 past the print head 10 at a certain constant speed. This is advantageous for smaller workpieces 60 whose size and weight allow a user to handle them. For larger workpieces, it is easier to perform the relative movement using the printing device 1 of the first embodiment.

### Fourth Embodiment

In a fourth embodiment, the printing device 1 of the first embodiment may be used. The fourth embodiment differs from the first embodiment in that the printing device 1 is provided with a different holding element 31.

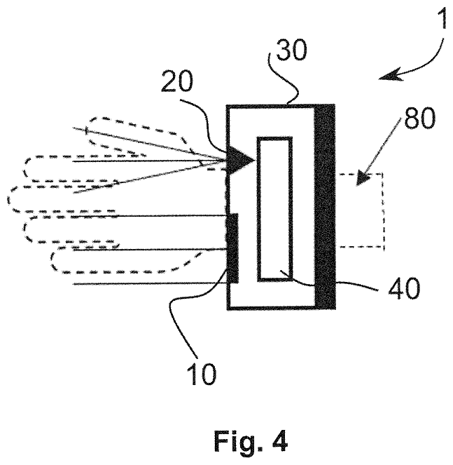

FIG. 4 illustrates a printing device 1 of a fourth embodiment, the setups of which are described in more detail with reference to FIG. 4.

The printing device 1 of the fourth embodiment is provided with a holding element 31 that is a holder for the wrist 80 of the user (FIG. 4). The printing device 1 of the fourth embodiment is thus wearable by the holding element 31. The printing device 1 of the fourth embodiment may thus be smaller than the printing device 1 of the first embodiment. This smaller design of the printing device 1 of the first embodiment is achieved by a smaller housing 30, as well as by a smaller user interface 40 compared to the first embodiment.

The printing device 1 of the fourth embodiment is releasably attached to the wrist of the user via the holding element 31 (FIG. 4). The holding element 31 may be, for example, a rubber band or a Velcro strap, which is attached to the housing 30 of the printing device 1 via two eyelets (not shown). Thus, the user can easily and securely attach the printing device 1 of the fourth embodiment to the wrist 80. Thus, for the printing operation, the user can merely guide the printing device 1 to the workpiece 60 by a simple hand movement for printing on the workpiece 60. This can simplify and speed up the printing process, since the user does not have to first reach for the printing device 1, as it is already arranged on the wrist.

Alternatively, the printing device 1 of the fourth embodiment may have a user interface 40, but may not have a touch display, for example. Possibly, the printing device 1 of the fourth embodiment may have buttons, or pushbuttons, or switches as a user interface 40. Furthermore, it is also possible to design the user interface 40 of the fourth embodiment in such a way that voice control is possible. Also, it is possible to design the user interface 40 of the fourth embodiment such that a known augmented reality glasses (AR-glasses) can be used to input data into the printing device 1. The aim of the printing device 1 of the fourth embodiment is to increase the mobility of the user by allowing both hands to be used freely for other applications.

### Fifth Embodiment

In a fifth embodiment, the printing device 1 of the first to fourth embodiments may be used. The fifth embodiment differs from the first, second and third embodiments in that the printing device 1 is provided with a different holding element 31.

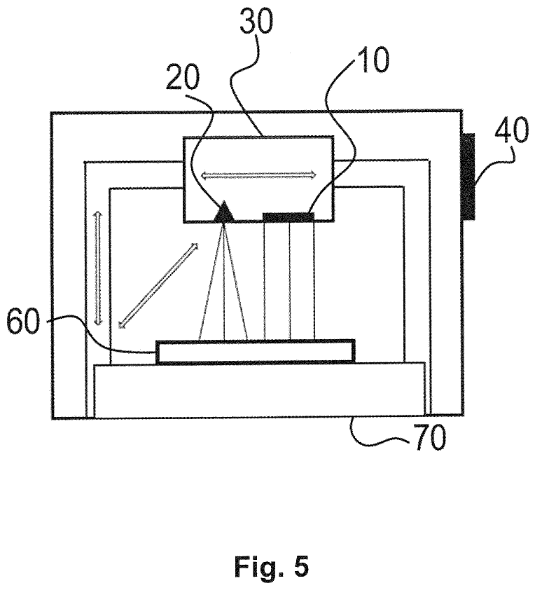

FIG. 5 illustrates a printing device 1 of a fifth embodiment, the setups of which are described in more detail with reference to FIG. 5.

The printing device 1 of the fifth embodiment provides a printing device 1 that can be inserted into a small mobile CNC table machine, into a medium to large CNC machine, and/or received up by a robotic arm.

In the specifically shown embodiment, a workpiece 60 is fixed on a CNC machine table 70 (FIG. 5). The printing device 1 of the fifth embodiment is attached to the CNC machine tool, so that it can move freely in all three spatial directions. The range of movement of the printing device 1 of the fifth embodiment is indicated by the three arrows in FIG. 5. The movement of the printing device 1 of the fifth embodiment may be effected by a motor, which is controlled by a controller. Thus, the print head 10 of the printing device 1 of the fifth embodiment can be moved to different positions of the workpiece 60.

### Method for Printing on a Workpiece

A method for printing on a workpiece is performed with a printing device, preferably with the printing device 1 according to one of the embodiments. In other words, all five embodiments of the printing device 1 may perform the method for printing a workpiece.

The method for printing on a workpiece 60 is provided for printing a workpiece 60 that comprises preferably at least partially wood, wood fiber containing materials, wood composite materials, veneer, plastic, or a combination thereof. The printing device 1 is configured to perform the method. The method comprises the following steps: determining and selecting a color spectrum; positioning a portable printing device 1, in particular a print head 10, at a section of the workpiece 60; providing at least two print media from at least two containers via a first interface to the print head; printing the section of the workpiece by the printing device, in particular by the print head 10, with the at least two print media. When printing the section of the workpiece 60, the at least two print media are provided to the print head simultaneously. The step of determining and selecting the color spectrum is performed by the controller, wherein the controller analyses the data of the first sensor 20 and outputs an order to print the color spectrum to the print head 10 based on the data of the first sensor 20.

The portable printing device 1 is versatile due to its low weight. The print height of the printing device 1, and thus the height of the print head 10, corresponds to that of an edge bandwidth of 12 mm to 63 mm. The print job to print a color spectrum may be generated by the controller based on data determined by the first sensor 20, or based on a manual selection of the user via the user interface 40. Additionally, the controller may receive data from a database via the second interface from an external device. The external device receives data from the controller of the printing device 1 and sends data back to the controller. The user interface 40 is a touch screen. The large touch screen 40 (e.g., 4.3″) can be used to display information about the determined surface and data of the database, and the user can select print jobs to print a color spectrum. Furthermore, the user can manually edit print jobs via the touchscreen 40. Multiple language selections are possible. The printing device can use a fast-drying and high-resolution ink with high adhesion.

During the printing process, the print head 10 must be manually moved past the surface of the workpiece 60 to be printed at a relatively constant speed. Since the fast manual movement is never carried out uniformly, an additional second sensor may ensure that the print media supply is regulated during the printing process. This ensures a precise and sharp printing result. The printing device 1 is designed for left-handed as well as right-handed or even two-handed use. In addition, a guide element 33 (not shown) is attached to the printing device 1. The guide element 33 are guide rails, which make a more precise printing result possible, since the printing device is aligned to the surface of the printing device.

The method for printing on a workpiece 60 further comprises the step: applying a material to the section of the workpiece 60 prior to positioning the printing device 1. Alternatively or additionally, the method comprises the step: removing a material on the section of the workpiece prior to the positioning the printing device 1, and prior to the step of applying a material to the section of the workpiece 60. Wherein in the step of detecting and selecting, data from an external device is further transmitted to the printing device 1 via a second interface.

Additionally, the positioning of the printing device 1 on a section of the workpiece 60 is carried out by a device holder 50 that is coupled to the housing 30. Alternatively or additionally, the positioning of the printing device 1 at a section of the workpiece 60 is carried out via a guide element 33, wherein the printing device 1 is moved along the guide element on a surface of the workpiece 60.

The method performs the further steps: detecting and analyzing a surface of the workpiece 60 at least in a section by a first sensor 20, wherein the first sensor 20 is connected to a controller; providing data about the detected and analyzed surface from the first sensor 20 to the controller, and wherein in the step of the determining and selecting the color spectrum, the data from the first sensor 20 is used.

Further, the printing method comprises a computer-implemented method for determining a surface structure of a workpiece, comprising the steps of: detecting and analyzing a surface structure of the workpiece 60 at least in a section by the first sensor 20; sending data containing information about the detected and analyzed surface structure from the first sensor to the controller; receiving data by the controller about the detected and analyzed surface structure from the first sensor 20; determining the color spectrum of the surface structure based on the received data; selecting the color spectrum; transmitting a print job to print the color spectrum from the controller to the print head of the printing device.

In the step of the determining the color spectrum of the surface structure, data is sent to the external device and data is received from the external device. The received data includes information about the determined surface structure.

Specifically, the method can be used to print a new edge band. In this case, the new edge band is first of all applied or glued to the workpiece 60. In most cases, this is done manually with an iron or alternatively with an edge banding machine if one is available. If the old or damaged edge band is still glued to a surface of the workpiece 60, this would of course have to be removed first. To minimize the risk of damaging the newly printed surface during the gluing process, the new edge band is always applied to the workpiece 60 first and is then digitally printed. Furthermore, a loose edge band makes handling during the manual digital printing process more difficult. Then, the method of printing the edge band applied to the workpiece 60 can be performed to print the workpiece edge. In this method, the desired target decor can be transferred either, via, for example, a USB interface, Bluetooth or via WLAN from a suitable data source (PC, laptop, tablet, etc.) of an external device in a suitable format and resolution to the printing device 1.

Optionally, an integrated scanning function may be provided by the first sensor 20, with which the decor available on site on a surface of the workpiece 60 is first scanned. In this way, even minor defects on the workpiece edge can be repaired by scanning the desired, correct surface of the edge and then repairing the defective area directly on site.

It is apparent to those skilled in the art that individual features each described in different embodiments may also be implemented in a single embodiment, provided they are not structurally incompatible. Similarly, various features described in the context of a single embodiment may also be provided in several embodiments individually or in any suitable sub-combination.

1. A printing device for printing on a workpiece, the workpiece comprising wood, wood fiber containing materials, wood composite materials, veneer, plastic, or a combination thereof, the printing device comprising:
a housing,
a holding element arranged on the housing,
a print head attached to a first side of the housing, and
a first interface communicatively and operatively connecting the print head to containers for print media,
wherein the printing device is portable.

2. The printing device according to claim 1, further comprising:
a device holder, preferably a robot arm or multi-axis head, which can be coupled to the housing, or
a guide element along which the printing device can be moved on a surface of the workpiece.

3. The printing device according to claim 1, in which the print head is configured to dispense a plurality of printing media simultaneously to the workpiece.

4. The printing device according to claim 1, further comprising a controller configured to control the print head.

5. The printing device according to claim 1, further comprising:
a first sensor on the first side of the housing adjacent to the print head, wherein the first sensor is configured to detect and analyze a surface of the workpiece at least in a section,
wherein the first sensor is connected to the controller and provides data about the detected and analyzed surface to the controller, wherein the print head is controllable based on the data from the first sensor.

6. A method for printing on a workpiece, the workpiece comrpising wood, wood fiber containing materials, wood composite materials, veneer, plastic, or a combination thereof, with the printing device according to claim 1, wherein the method comprises the following steps:
selecting a decor;
positioning a print head of a portable printing device on a section of the workpiece;
providing print media from containers to the print head via a first interface; and
printing the section of the workpiece with the print media.

7. The method for printing on a workpiece according to claim 6, further comprising the step of:
applying a material to the section of the workpiece prior to positioning the printing device, or
removing a material on the section of the workpiece before positioning the printing device and before the step of applying a material on the section of the workpiece.

8. The method for printing on a workpiece according to claim 6, wherein in the step of the selecting, data is further transferred from an external device to the printing device via a second interface.

9. The method for printing on a workpiece according to claim 6, wherein:
the positioning the printing device on a section of the workpiece is performed by a device holder that is coupled to a housing of the printing device, or
the positioning the printing device on a section of the workpiece is performed via a guide element, and the printing device is moved along a surface of the workpiece by the guide element.

10. The method for printing on a workpiece according to claim 6, wherein during the printing of the section of the workpiece, the print media are simultaneously provided to the print head.

11. The method for printing on a workpiece according to claim 6, further comprising:
detecting and analyzing a surface of the workpiece at least in a section by a first sensor, wherein the first sensor is connected to a controller, and
providing data about the detected and analyzed surface from the first sensor to the controller,
wherein in the step of the selecting the decor, the data from the first sensor is used.

12. The method for printing on a workpiece according to claim 6, wherein the step of selecting the decor is performed by the controller, wherein the controller evaluates the data of the first sensor and outputs an order to print the decor to the print head based on the data of the first sensor.

13. The method of printing a workpiece according to claim 6, further comprising:
a computer-implemented method for determining a surface structure of a workpiece, comprising the steps of:
detecting and analyzing a surface structure of the workpiece at least in a section by the first sensor;
sending data containing information of the detected and analyzed surface structure from the first sensor to the controller;
receiving data by the controller about the detected and analyzed surface structure from the first sensor;
determining by the controller the existing decor of the surface structure based on the received data;
selecting the decor; and
transmitting a print job to print the color spectrum from the controller to the print head of the printing device.

14. A computer-implemented method for determining a surface structure of a workpiece according to claim 13, wherein the determining the existing decor of the surface structure comprises sending data to the external device and receiving data from the external device, wherein the received data comprises information about the determined surface structure.
